(19) United States
(12) Patent Application Publication
(10) Pub. No.: US 2015/0066751 A1
(43) Pub. Date: Mar. 5, 2015

(54) Financial Transaction Error Detection

(71) Applicant: Bank of America Corporation, Charlotte, NC (US)

(72) Inventors: Kathleen P. Minnis, Jacksonville, FL (US); David W. Woodacre, Charlton, MA (US)

(21) Appl. No.: 14/537,217

(22) Filed: Nov. 10, 2014

Related U.S. Application Data
(63) Continuation of application No. 12/686,444, filed on Jan. 13, 2010.
(60) Provisional application No. 61/256,483, filed on Oct. 30, 2009.

(51) Int. Cl. G06Q 20/38

(52) U.S. Cl. CPC G06Q 20/38
USPC 705/39

(57) ABSTRACT

A system and method for receiving transaction data and identifying errors within the transaction data is provided. The transaction data may be received at a transaction data processing system and transactions having errors associated with them may be identified. In some arrangements, the identified transactions may be edited or manipulated, for instance, by a user. In some examples, an error type may be associated with the identified transactions. The identified transactions may be transmitted to a transaction error resolution system for resolution of the error and/or adjustment.

### CROSS REFERENCE TO RELATED APPLICATIONS

This application is a continuation of and claims priority to U.S. application Ser. No. 12/686,444, filed Jan. 13, 2010, entitled “FINANCIAL TRANSACTION ERROR DETECTION,” which is a non-provisional application of and claims the benefit of priority from U.S. application Ser. No. 61/256,483, entitled “FINANCIAL TRANSACTION ERROR DETECTION,” filed Oct. 30, 2009.

### BACKGROUND

Processing of financial transactions is prone to error due to the substantial volume of transactions conducted on a daily basis and the speed with which the transactions must be processed due to customer expectations and demand. Consequently, adjustments are often necessary to correct any errors such as errors in deposit and withdrawal amounts. Currently, financial institutions make such adjustments with other financial institutions through various payment networks including the Federal Reserve and private financial clearinghouses. However, data transmitted to the financial institution may include various types of transactions, including those needing adjustment and those not needing adjustment. In addition, the data transmitted may include errors and may include data from various or multiple sources. This often requires a user or analyst to manually sort data, identify any errors, process adjustments, and the like, which can be time consuming and inefficient. It would be advantageous to provide an automated system for identifying errors, sorting data and generating reports regarding transactions requiring an adjustment.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

According to one or more aspects, data may be received at a transaction processing module. The data may, in some examples, including transaction records, transactions requiring adjustment due to an encoding error, misread, etc., and the like. The data may be automatically sorted to identify transactions that may include an error and/or may require an adjustment. Data for these transactions may then be extracted from the originally received data and may be processed or edited to identify the type of error (misread, encoding error, etc.). In some arrangements, the data may include an adjustment to be made to the account of the transacting customer. In some examples, a case may automatically be generated based on the extracted and/or edited data. The case may include the identified incorrect transaction and any associated information. The case may then be transmitted to a case transaction processing system where the case will be processed to complete any adjustment, etc. in order to correct the error associated with the transaction. In some arrangements, a report may be generated including one or more extracted and/or edited transactions.

### BRIEF DESCRIPTION OF THE DRAWINGS

The present disclosure is illustrated by way of example and not limited in the accompanying figures in which like reference numerals indicate similar elements.

FIG. 1 illustrates an example of a suitable operating environment in which various aspects of the disclosure may be implemented.

FIG. 2 illustrates an example network environment for processing identifying financial transactions having errors and processing those transactions according to one or more aspects described herein.

FIG. 3 illustrates one example method by which a financial institution receives transaction data, identify transactions having an error and process a remedy to those errors according to one or more aspects described herein.

FIG. 4 illustrates one example listing of transaction data as may be received at a transaction data processing system according to one or more aspects described herein.

FIG. 5 illustrates one example listing of transactions identified as including an error at the transaction data processing system that may be transmitted to a transaction error resolution system for further processing according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

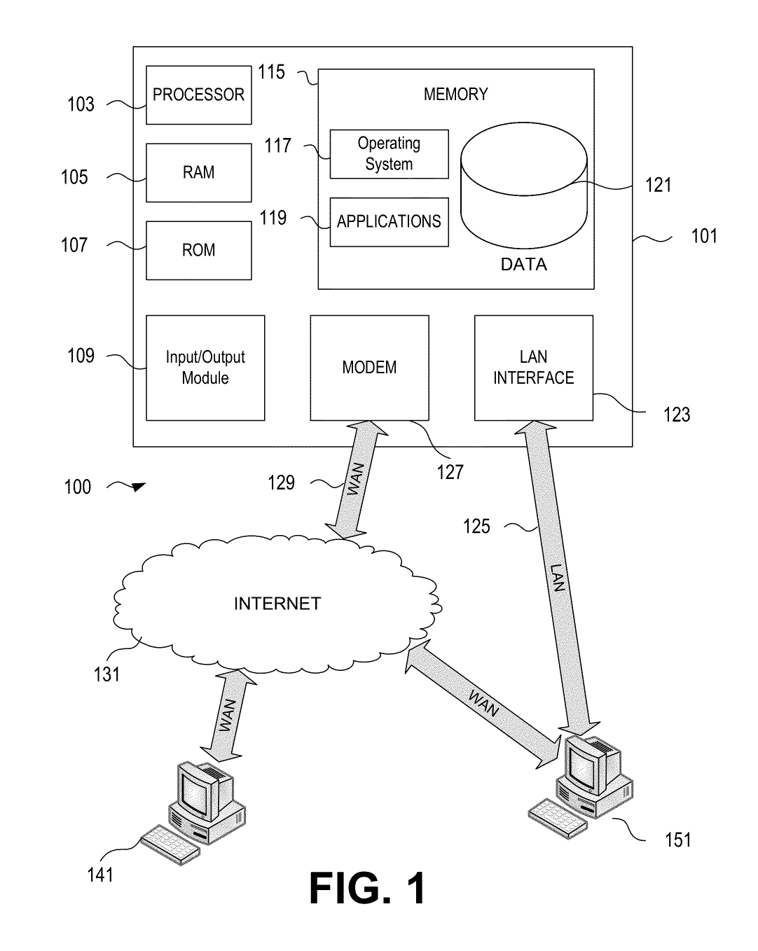

FIG. 1 illustrates a block diagram of a generic computing device 101 (e.g., a computer server) in computing environment 100 that may be used according to an illustrative embodiment of the disclosure. The computer server 101 may have a processor 103 for controlling overall operation of the server and its associated components, including random access memory (RAM) 105, read-only memory (ROM) 107, input/output (I/O) module 109, and memory 115.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown).

The server 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the computer 101 may be connected to the LAN 125 through a network interface or adapter 123. When used in a WAN networking environment, the server 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks, etc.) including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, data structures, etc. that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

The system, devices and networks of FIG. 1 may, in one or more arrangements, be used to provide transaction adjustment functionality. Transaction adjustments are used to resolve discrepancies between what is claimed as owed or paid and what is actually owed or paid. For example, a check adjustment may be needed where Bank A receives $100 from Bank B for a $1000 check deposited at Bank A. The error may result from a misread of the check or check image, amount entry error, check reference number entry error or the like. Accordingly, an adjustment must be applied to the check transaction to compensate Bank A for the difference, i.e., $900. A system may be used to streamline the research and resolution of transaction adjustment cases. The system may provide automated workflow procedures for the entry and building of transaction adjustment cases, organization of transaction adjustment cases, creation of user interfaces for data entry, editing and viewing of case information including check images, interfacing with legacy and third party applications and the like. For example, the system may receive data from a transaction data collection system and automatically populate fields to build a transaction case.

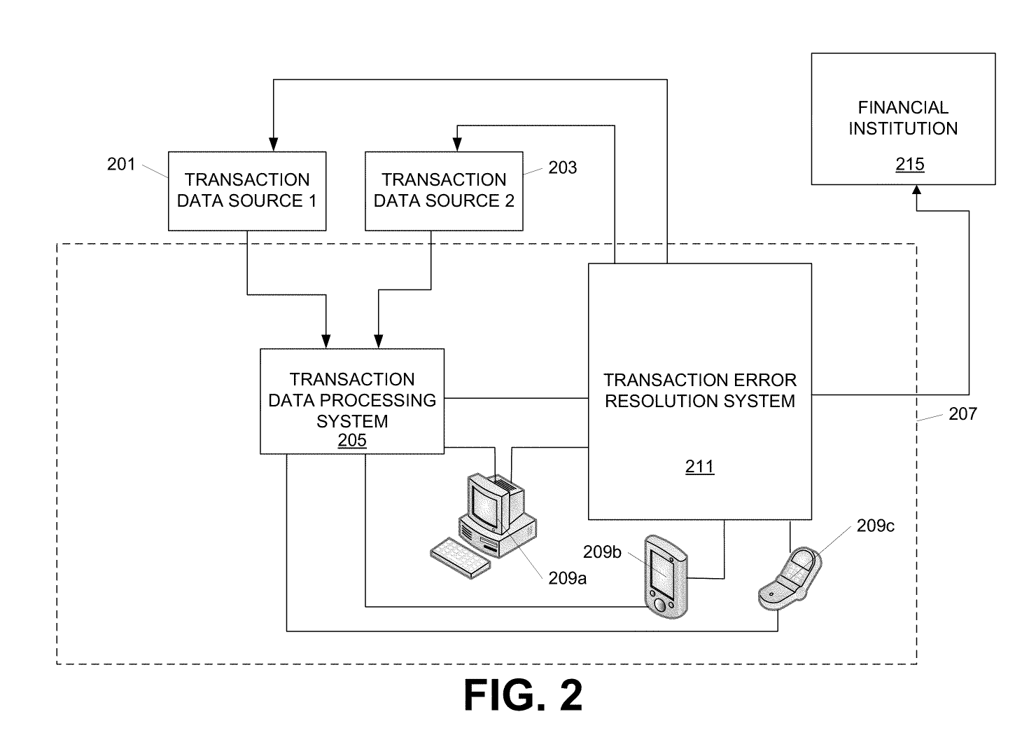

FIG. 2 illustrates a transaction processing system that may be used in accordance with aspects of this invention. Transaction data may be received from external sources 201 and 203. External sources 201 and 203 may include payment networks, such as SVPCO. Data received from sources 201, 203 may be received as a file that may include multiple transactions. For instance, transactions from a predetermined period of time, one or more financial institutions, etc. may be transmitted in one file or transmission. Additionally or alternatively, the data received may include various types of transactions, including deposits, withdrawals, payments, and the like. In some instances, the transactions may include transactions that have an error associated with the transaction and may need an adjustment in order to correct the error. For instance, one or more transactions transmitted with the data may have an encoding error, misread, duplicate check, missing item, and the like. These transactions may require additional processing and/or an adjustment made to one or more accounts.

In some examples, the transaction data may be received through a wide area network, such as the Internet, by a transaction data processing system 205. The transaction data processing system may be resident at a financial institution, e.g., financial institution 207, to which the transactions are directed or may be provided by a third party. The transaction data processing system 205 may be configured to receive the transaction data and sort and/or analyze the data to determine transactions having errors and/or requiring additional processing, such as an adjustment to an account associated with the transaction. The transaction data processing system 205 may interface with one or more user terminals 209 in order to, in some examples, identify transactions having an error, edit various transaction data received, manipulate portions of the data and the like, for entry into a transaction error resolution system 211. In some examples, an error type may be associated with a transaction identified as having an error at the transaction data processing system 205. These error types may, in some examples, be used to sort transaction data.

The data including transactions identified as having errors may be received at the transaction error resolution system 211. This system 211 may further process the data associated with the transactions. For instance, the transaction error resolution system may facilitate remedying the error, such as processing an adjustment, etc. In some examples, the transaction error resolution system 211 may act as a data warehouse for transaction adjustment information in addition to other types of transaction information. The transaction error resolution system 211 may further be configured to organize data, facilitate the viewing and editing of transactions, send and receive information to and from various other systems and the like. For example, system 211 may transmit transaction information to a third party payment network such as SVPCO or a government financial service system 201 such as the Federal Reserve upon resolution of a check adjustment request. In another example, system 211 may communicate with one or more other financial institutions (e.g., institution 215) to indicate that transactions such as check adjustments have been resolved or processed. In one or more arrangements each of system 211, user terminals 209 and transaction data receiving system 205 may be resident in financial institution 207. In still other examples, transaction error resolution system 211 may interface with user terminals 209 to receive user input/instructions regarding adjustments to user accounts, edits to transaction data, and the like.

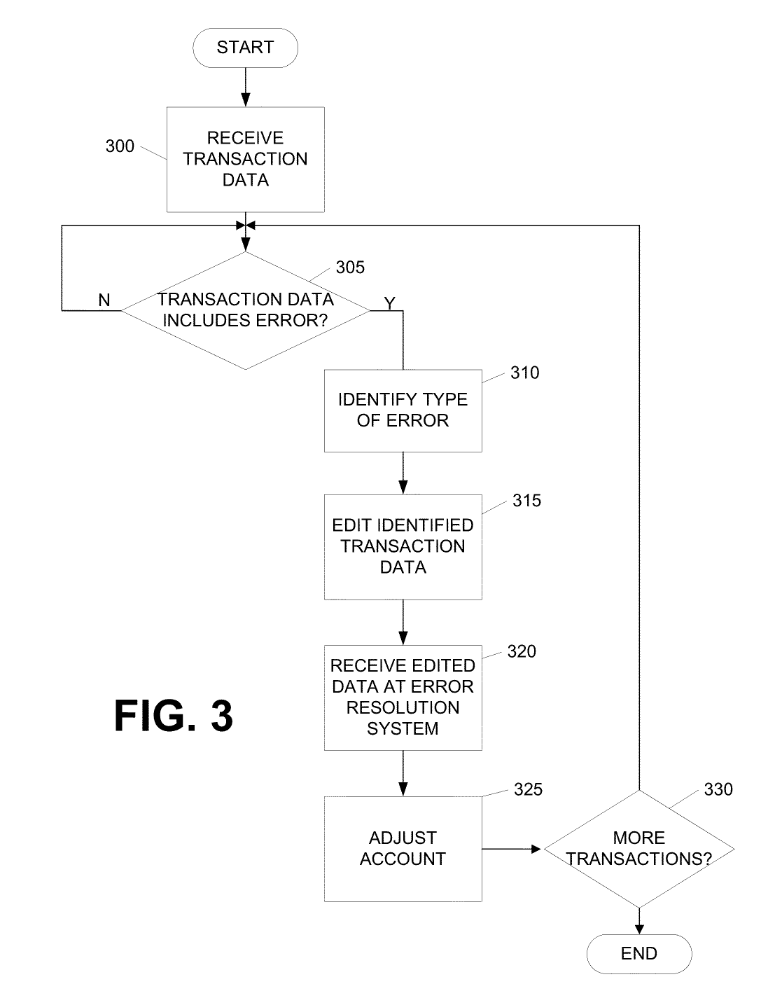

FIG. 3 illustrates a method by which transaction data may be received and errors may be identified and edited for adjustment. In step 300 transaction data is received, for instance, at a transaction data processing system (such as system 205 in FIG. 2). As discussed above, transaction data may include transactions from various financial institutions and may be transmitted from one or more clearinghouses, such as SVPCO. Additionally or alternatively, the transaction data received may include data regarding transactions having errors and those not having errors. Also, the data may include transactions of various types. In some examples, receiving transaction data may include receiving a set or listing of transactions, which may include transactions that include errors and transactions that do not include errors. In step 305, the transaction processing system may identify transactions having errors. If a transaction does not have an error in step 305, the method ends and no further processing may be desired for that transaction. If a transaction is identified as having an error in step 305, the error type may be identified in step 310. For instance, the error may include an encoding error, check misread, and the like. In some examples, the data may be sorted by the type of error identified. In step 315, the transaction identified as having an error may be edited or manipulated, in some examples by a user, to modify any information, review and confirm transaction data, and the like. For instance, fields such as submission date, settlement date, category type, and the like may be edited for record inclusion or exclusion in the edited transaction data. In step 320 the edited transaction data may be received at an error resolution system, such as transaction error resolution system 211 in FIG. 2. Any adjustments, etc. needed to remedy the error in the transaction may be processed at the transaction error resolution system. In some examples, a user may interface with the transaction error resolution system in order to facilitate the correction/adjustment associated with the error. In step 325, any adjustment is made to the user account in order to remedy the error associated with the transaction. In step 330, a determination is made as to whether additional transactions must be analyzed to determine if they include errors. If there are additional transactions, the method returns to step 305 to determine whether the transaction includes an error. If no, the process ends.

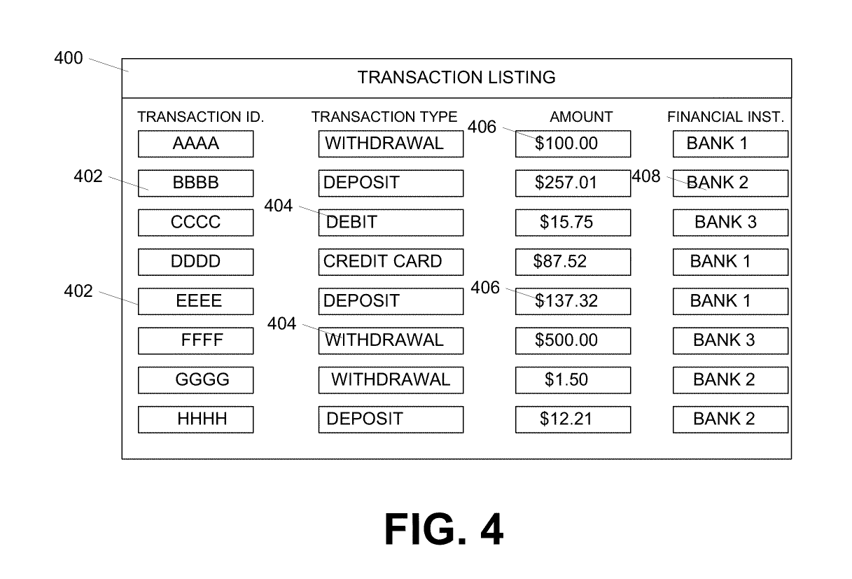

FIG. 4 illustrates one example listing of transactions that may be received at a transaction data processing system. The listing 400 includes a plurality of transactions identified by a transaction identification number in fields 402. A transaction type 404 may be associated with each transaction identification number and various types of transactions are listed. In field 406, the amount associated with each transaction may be listed and in field 408 the bank or other financial institution associated with the transaction may also be listed. For instance, the bank identified may be the bank at which the error resolution system is resident or it may be another bank at which a transaction occurred that may be related to the financial institution at which the system is resident.

The example listing 400 shown includes various transactions, transactions types, etc. from various banks or other financial institutions. However, the listing 400 does not identify transactions that include or may include an error or may require adjustment to a user account, etc. When the listing 400 is received at the transaction data processing system, the transactions may be scanned or otherwise scrutinized in order to identify transactions having errors. For instance, transactions having irregular amounts may be scrutinized to determine whether an error exists (e.g., dollar amounts less than a certain predefined threshold ($1, $10, etc.), dollar amounts over a certain predefined threshold, and the like. In some examples, fields such as submission date, settlement date, category type, and the like may be edited for record inclusion or exclusion in the edited transaction data.

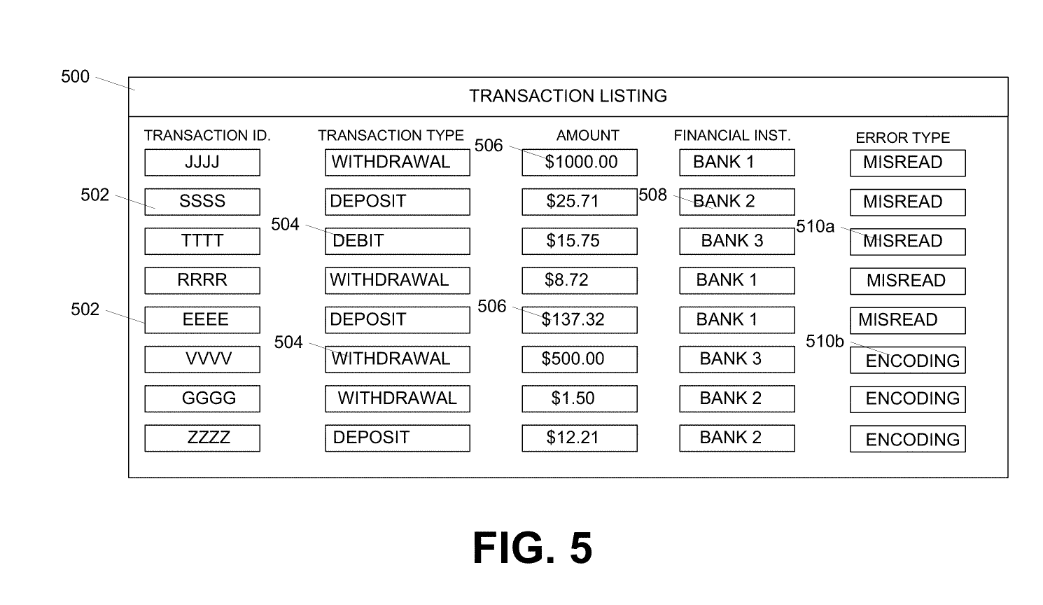

Once the errors are identified, and processed as desired, a listing of transactions having identified errors may be transmitted to the transaction error resolution system. FIG. 5 illustrates one example listing of transactions received at the transaction error resolution system that have been identified as having errors and/or requiring adjustment at the transaction data processing system. Similar to the listing 400 in FIG. 4, the listing 500 may include transactions identified by a transaction identification number in field 502, a transaction type in field 504, an amount in field 506 and a bank or other financial institution in field 508. In addition, listing 500 includes fields 510 which identify the type of error associated with that particular transaction. In some arrangements, such as shown in FIG. 5, the listing 500 may sort the transactions by error type. For instance, transactions having an encoding error, such as 510a, may be grouped together while transactions having an encoding error, such as 510b, may be grouped together. Various other criteria for sorting may also be used without departing from the invention. In some arrangements, listings, such as listing 600, may include an amount of adjustment and/or an amount of the error.

The methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present invention. The description is thus to be regarded as illustrative instead of restrictive on the present invention.

What is claimed is:

1. A method, comprising:
receiving transaction data at a transaction data processing system;
identifying transactions, at the transaction data processing system, within the received transaction data having an error;
editing the identified transactions; and
transmitting the edited identified transactions to a transaction error resolution system for resolution of the error in the identified transactions, wherein the transaction error resolution system is configured to adjust at least one user account to resolve the error in the identified transactions.

2. The method of claim 1, wherein the step of editing the identified transactions includes identifying an adjustment amount or an error amount.

3. The method of claim 1, wherein the step of receiving transaction data includes receiving transaction data relating to transactions having errors and transactions not having errors.

4. The method of claim 1, wherein the step of receiving transaction data includes receiving transaction data from a plurality of sources.

5. The method of claim 4, wherein the plurality of sources is a plurality of financial institutions.

6. The method of claim 1, further including identifying an error type in the identified transactions.

7. The method of claim 6, further including sorting the transmitted edited identified transactions by error type.

8. A method, comprising:
receiving, by a system having a processor, transaction data at a transaction data processing system associated with a financial institution;
determining, by the system, that the transaction data includes at least one transaction including an error;
identifying, by the system, a type of error associated with the at least one transaction;
editing, by the system, the transaction data associated with at least one transaction; and
transmitting, by the system, the edited transaction to a transaction error resolution system associated with the financial institution for resolution of the determined error, wherein the transaction error resolution system is configured to adjust at least one user account to resolve the error in the identified transactions.

9. The method of claim 8, wherein the transaction data is received from a source outside the financial institution.

10. The method of claim 8, wherein the step of editing the transaction data associated with the at least one transaction includes identifying an adjustment amount or an error amount.

11. The method of claim 8, wherein the step of receiving transaction data includes receiving transaction data from a plurality of sources.

12. The method of claim 8, further including adjusting an account at the financial institution based on the edited data associated with the at least one transaction.

13. An apparatus comprising:
a processor; and
memory operatively coupled to the processor and storing computer readable instructions that, when executed, cause the apparatus to:
receive transaction data at a transaction data processing system;
identify transactions, at the transaction data processing system, within the received transaction data having an error;
edit the identified transactions; and
transmit the edited identified transactions to a transaction error resolution system for resolution of the error in the identified transactions, wherein the transaction error resolution system is configured to adjust at least one user account to resolve the error in the identified transactions.

14. The apparatus of claim 13, wherein editing the identified transactions includes identifying an adjustment amount or an error amount.

15. The apparatus of claim 13, wherein the received transaction data includes transaction data relating to transactions having errors and transactions not having errors.

16. The apparatus of claim 13, wherein the received transaction data includes transaction data from a plurality of sources.

17. The apparatus of claim 13, further including instructions that, when executed, further cause the apparatus to identify an error type in the identified transactions.

18. One or more non-transitory computer readable media storing computer readable instructions that, when executed, cause an apparatus to:
receive transaction data at a transaction data processing system;
identify transactions, at the transaction data processing system, within the received transaction data having an error;
edit the identified transactions; and
transmit the edited identified transactions to a transaction error resolution system for resolution of the identified transactions, wherein the transaction error resolution system is configured to adjust at least one user account to resolve the error in the identified transactions.

19. The one or more computer-readable media of claim 18, wherein editing the identified transactions includes identifying an adjustment amount or an error amount.

20. The one or more computer-readable media of claim 18, wherein the received transaction data includes transaction data relating to transactions having errors and transactions not having errors.
